(19) United States
(12) Patent Application Publication
(10) Pub. No.: US 2026/0046127 A1
(43) Pub. Date: Feb. 12, 2026

(54) INFORMATION PROCESSING APPARATUS, AUTHENTICATION SYSTEM, METHOD, COMPUTER-READABLE STORAGE MEDIUM, AND IMAGE-FORMING APPARATUS

(71) Applicant: CANON KABUSHIKI KAISHA, Tokyo (JP)

(72) Inventor: YUTA HOJO, Tokyo (JP)

(21) Appl. No.: 19/273,358

(22) Filed: Jul. 18, 2025

(30) Foreign Application Priority Data
Aug. 9, 2024 (JP) 2024-134474

(51) Int. Cl. H04L 9/14; H04L 9/32

(52) U.S. Cl. CPC H04L 9/14; H04L 9/3247

(57) ABSTRACT

There is provided an information processing apparatus for remanufacturing a device that can be attached to an image-forming apparatus. The device includes a memory with a rewritable storage area and a component element involved in an image-forming operation. The information processing apparatus includes: a storage that pre-stores a private key for signature generation, a public key corresponding to the private key, and an electronic certificate for certifying reliability of the public key; a connection interface for the information processing apparatus to connect to the device; and control circuitry. The control circuitry obtains characteristic information representing a characteristic of the component element after remanufacture, generates a digital signature of the characteristic information using the private key, and writes the characteristic information, the digital signature, the public key, and the electronic certificate to the storage area of the memory of the device.

### BACKGROUND

### Field of the Technology

The present disclosure relates to an information processing apparatus, an authentication system, a method, a computer-readable storage medium, and an image-forming apparatus.

### Description of the Related Art

An image-forming apparatus such as a copying machine, a printer, a facsimile receiver, and a multi-function peripheral forms images on a sheet using a development agent such as toner or ink and a consumable member such as a photosensitive drum. Such a consumable component element is often housed inside a device that can be attached to and detached from the image-forming apparatus. Thus, when the development agent is depleted or the component element has no remaining service life, the user attaches a new device to the image-forming apparatus. Japanese Patent Laid-Open No. 2023-106130 describes a cartridge type of device (for example, a process cartridge) that is stationarily attached to an image-forming apparatus and a replenishing type of device (for example, a replenishment pack) that is temporarily attached to the image-forming apparatus when the development agent is replenished.

In recent years, due to increasing environmental concerns, methods are being looked into for designing in advance how to reuse spent devices in image-forming apparatuses without discarding the devices. For example, in order to reuse devices, a remanufacturing service provider may perform the work of collecting spent devices and replenishing development agents and replacing worn members. WO 2022/173444 A1 describes technology for ensuring appropriate operation of an image-forming apparatus when a device is being reused in which an apparatus authenticated by a cloud service writes data relating to the remanufactured device to a device memory.

However, with the technology of WO 2022/173444 A1, each time data is written to the memory of the device to be remanufactured, it is necessary for the apparatus of the remanufacturer to communicate with a server existing in a cloud environment via a network. This leads to excessive communication cost and calculation cost. Meanwhile, if data is allowed to be freely written to the device memory, reliability of the remanufactured device cannot be ensured.

### SUMMARY

The present disclosure aims at providing a mechanism that ensures reliability of a remanufactured device without the necessity to make access to a server at the time of remanufacture.

According to an aspect, there is provided an information processing apparatus for remanufacturing a device that can be attached to and detached from an image-forming apparatus, the device including a memory that has a rewritable storage area and a component element involved in an image-forming operation by the image-forming apparatus, the information processing apparatus including: a storage configured to pre-store a first private key for signature generation, a first public key corresponding to the first private key, and an electronic certificate for certifying reliability of the first public key; a connection interface for the information processing apparatus to connect to the device; and control circuitry, wherein the control circuitry is configured to: obtain characteristic information representing a characteristic of the component element after remanufacture; generate a digital signature of the characteristic information using the first private key; and write the characteristic information, the digital signature, the first public key, and the electronic certificate to the storage area of the memory of the device.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic view for a schematic configuration of an authentication system according to an embodiment.

FIG. 2 is a schematic cross-sectional view illustrating an example of a physical configuration of the inside of a cartridge.

FIG. 3 is a schematic cross-sectional view illustrating an example of a physical configuration of the inside of a printer to which the cartridge is attached.

FIG. 4 is a schematic perspective view illustrating an example of an external appearance of a connection interface of a remanufacturing apparatus.

FIG. 5 is a block diagram illustrating an example of a configuration of a certificate authority according to an embodiment.

FIG. 6 is a block diagram illustrating an example of a configuration of the remanufacturing apparatus according to an embodiment.

FIG. 7 is a block diagram illustrating an example of a configuration of the cartridge according to an embodiment.

FIG. 8 is an explanatory diagram of an example of a configuration of a storage area of a cartridge memory.

FIG. 9 is a block diagram illustrating an example of a configuration of a control function of the printer according to an embodiment.

FIG. 10 is a sequence diagram illustrating an example of a flow of certificate preparation processing executed prior to remanufacture.

FIG. 11 is a sequence diagram illustrating an example of a flow of writing processing executed at the time of remanufacture of the cartridge.

FIG. 12 is a sequence diagram illustrating an example of a flow of cartridge authentication processing executed by the printer.

FIG. 13 is a flowchart illustrating an example of a flow of certificate verification processing according to a first embodiment example.

FIG. 14 is a flowchart illustrating an example of a flow of certificate verification processing according to a second embodiment example.

FIG. 15 is a flowchart illustrating an example of a flow of certificate verification processing according to a third embodiment example.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. System Overview

### <1-1. Overall Configuration>

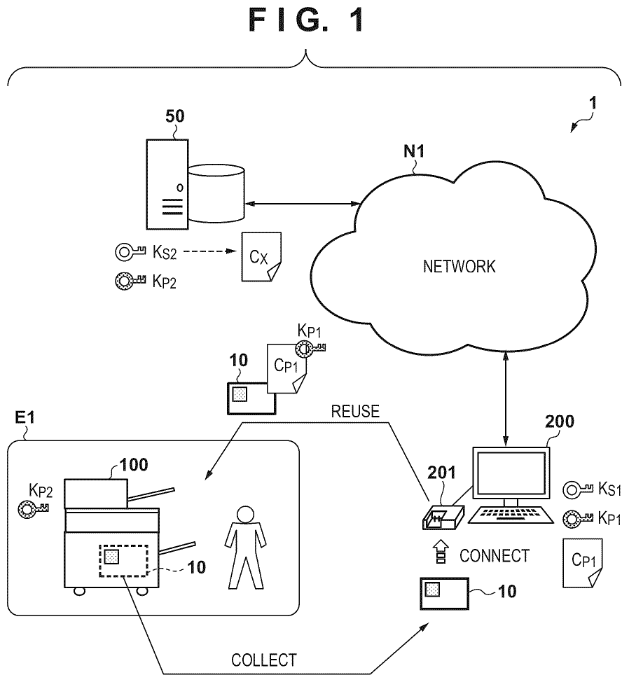

FIG. 1 is a schematic view for a schematic configuration of an authentication system 1 according to an embodiment. As illustrated in FIG. 1, the authentication system 1 includes a cartridge 10, a printer 100, a remanufacturing apparatus 200, and a certificate authority 50.

The cartridge 10 is a device that can be attached to and detached from the printer 100. The printer 100 operates in a state where with the cartridge 10 is attached to it. In the present embodiment, an example in which the cartridge 10 is a process cartridge will be mainly described. In other embodiments, the cartridge 10 may be a toner cartridge, an ink cartridge, or another type of cartridge. Note that the technology according to the present disclosure can be applied to other types of devices such as a replenishment pack that is temporarily attached to an image-forming apparatus to replenish the development agent.

The printer 100 is an image-forming apparatus installed in a user environment E1. In the present embodiment, an example in which the printer 100 is a laser printer that forms images on sheet via electro-photography will be mainly described. In other embodiments, the printer 100 may be an inkjet printer or another type of printer. The printer 100 may be a monochrome printer or a color printer. Note that the technology according to the present disclosure can be applied to another type of image-forming apparatus such as a copying machine or a multi-function peripheral.

The remanufacturing apparatus 200 is an information processing apparatus for remanufacturing the cartridge 10. The remanufacturing apparatus 200 is typically used by the remanufacturer of the cartridge 10. In the present embodiment, the remanufacturer is a service provider different from the manufacturer of the printer 100. In other embodiments, the remanufacturer may be the same as the manufacturer of the printer 100. The remanufacturing apparatus 200 may be a general-purpose information processing apparatus such as a personal computer (PC) or may be a dedicated apparatus for writing information to the cartridge 10. The remanufacturing apparatus 200 includes a connection interface 201 described below for connecting to the cartridge 10. Also, the remanufacturing apparatus 200 connects to a network N1.

The network N1 may be the Internet, a cloud network, a private network, or any combination thereof.

The certificate authority 50 is a certificate authority associated with the manufacturer of the cartridge 10 (and the printer 100) that includes a function for issuing a so-called public key certificate. The certificate authority 50 may be a private certificate authority introduced for the authentication system 1. The certificate authority 50 may be operated by the manufacturer of the cartridge 10 or may be operated by a third party commissioned by the manufacturer, for example. The certificate authority 50 is connected to the network N1. The remanufacturing apparatus 200 can communicate with the certificate authority 50 via the network N1.

### <1-2. Cartridge Overview>

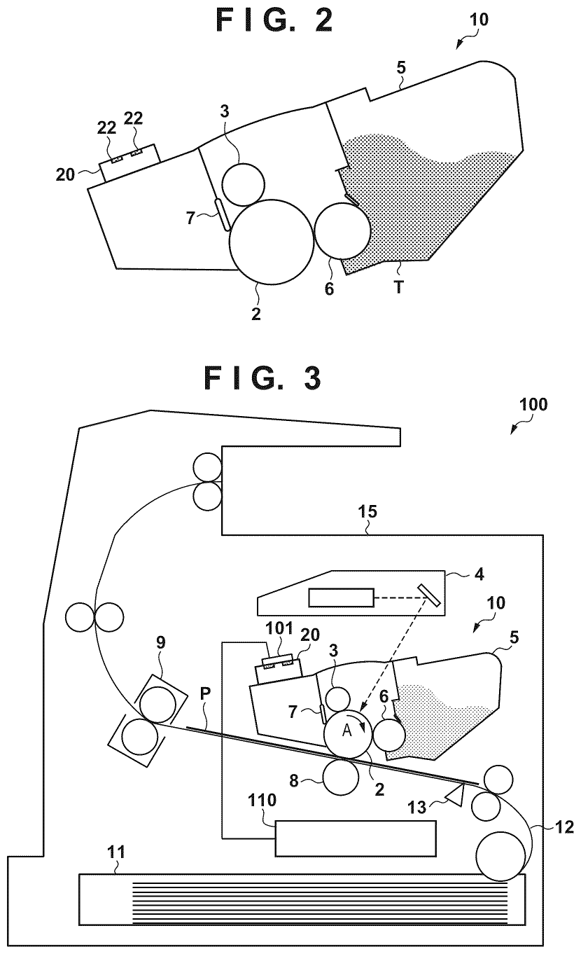

FIG. 2 is a schematic cross-sectional view illustrating an example of a physical configuration of the inside of the cartridge 10. As illustrated in FIG. 2, the cartridge 10 includes, as component elements involved in the image-forming operation, a photosensitive body 2, a charging roller 3, a toner container 5, a developing roller 6, a cleaning blade 7, and a cartridge memory 20. The photosensitive body 2, the charging roller 3, the developing roller 6, and the cleaning blade 7 are members driven by the printer 100 in the image-forming operation of the printer 100. The toner container 5 houses toner T as the development agent. The toner T is supplied to the printer 100 when the printer 100 forms a toner image. The cartridge memory 20 is a storage that stores identification information of the cartridge 10, characteristic information indicating the characteristics of the component elements involved in the image-forming operation, and information for certifying the reliability of the cartridge 10 described below. The cartridge memory 20 includes a pair of connection terminals 22. When the cartridge 10 is attached to the printer 100, the cartridge memory 20 is electrically connected to the printer 100 via the connection terminals 22.

### <1-3. Printer Overview>

FIG. 3 is a schematic cross-sectional view illustrating an example of a physical configuration of the inside of the printer 100 to which the cartridge 10 is attached. As illustrated in FIG. 3, the printer 100 includes an exposure device 4, a transfer roller 8, a fixing device 9, a cassette 11, a conveying path 12, a top sensor 13, a discharge tray 15, a connection terminal 101, and a controller 110.

The photosensitive body 2 is an image carrier that is rotationally driven in the direction of arrow A in the image-forming operation. The charging roller 3 is applied with a charging voltage and uniformly charges the surface of the photosensitive body 2. The exposure device 4 forms an electrostatic latent image on the surface of the photosensitive body 2 by exposing the surface of the photosensitive body 2 to laser light according to input image data from the controller 110. The developing roller 6 is applied with a development voltage, develops the electrostatic latent image by the toner T housed in the toner container 5 being supplied to the photosensitive body 2, and forms a toner image on the surface of the photosensitive body 2.

The cassette 11 houses a stack of sheets. In the image-forming operation, the sheets P are fed from the stack of sheets in the cassette 11 one at a time to the conveying path 12. The sheet P is conveyed along the conveying path 12 by a plurality of conveyance rollers. The top sensor 13 detects the leading end and the trailing end of the sheet P. The controller 110 controls the timing of sending the sheet P to a transfer position where the transfer roller 8 is arranged and the timing of feeding the subsequent sheets on the basis of detection signals from the top sensor 13. The transfer roller 8 is applied with a transfer voltage and transfers the toner image formed on the surface of the photosensitive body 2 onto the sheet P. The cleaning blade 7 removes the toner remaining on the surface of the photosensitive body 2. The fixing device 9 fixes the toner image to the sheet P by heating and pressing the sheet P. After the sheet P passes through the fixing device 9, the sheet P is discharged to the discharge tray 15.

The controller 110 is connected to the cartridge 10 attached to the printer 100 via the connection terminal 101 and controls the image-forming operation of the printer 100 on the basis of the characteristics indicated by the characteristic information read out from the cartridge 10. For example, on the basis of the member characteristic information described below, image-forming conditions such as charging voltage, development voltage, transfer voltage, amount of laser light, and process speed may be determined. Also, on the basis of the toner characteristic information described below, the remaining amount of toner may be determined. The configuration of the controller 110 will be described below in more detail.

Note that in the present embodiment, an example in which the cartridge 10 connects to the controller 110 via the connection terminal via a wired connection is mainly described. However, in other embodiments, the cartridge 10 may connect to the controller 110 via an antenna, for example, via a wireless connection. This also applies to the connection between the cartridge 10 and the remanufacturing apparatus 200.

### <1-4. Cartridge Remanufacture>

The user, for example, purchases the cartridge 10 from the manufacturer of the cartridge 10 (typically, the same as the manufacturer of the printer 100) as a new product, attaches the cartridge 10 to the printer 100, and uses the printer 100. When the printer 100 repeats the image-forming operation, the toner inside the cartridge 10 gradually depletes and the members of the cartridge 10 wear until they have no remaining service life (for example, the rollers wear). The user detaches the cartridge 10 from the printer 100 and attaches a newly purchased cartridge in the printer 100. As illustrated in FIG. 1, the spent cartridge 10 is collected by the remanufacturer.

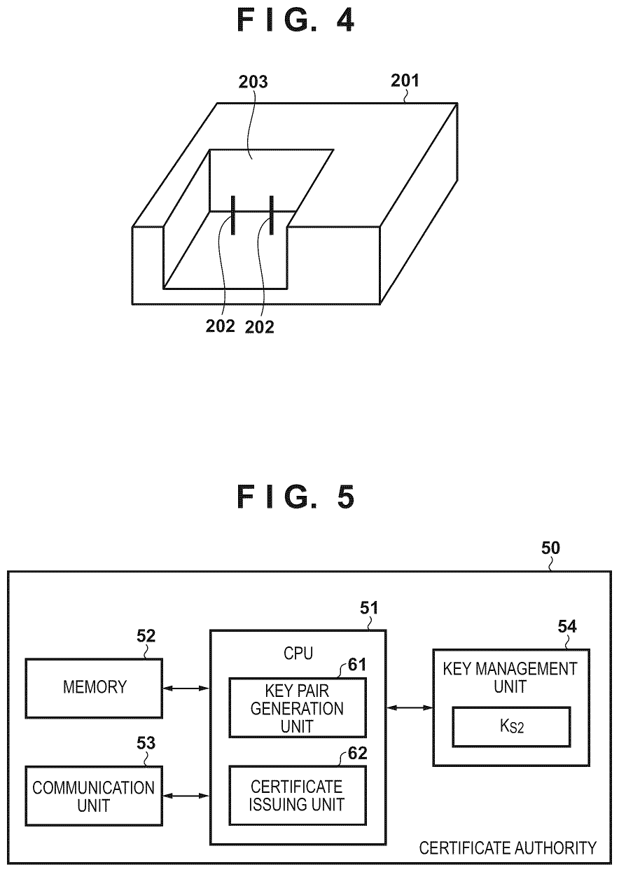

The remanufacturer, for example, performs remanufacturing works of cleaning the toner container 5 of the collected cartridge 10, replenishing the toner T in the toner container 5, and cleaning or (as necessary) replacing the members such as the rollers and blades. Also, the remanufacturer connects a connection interface 201 of the remanufacturing apparatus 200 to the cartridge 10. FIG. 4 is a schematic perspective view illustrating an example of the external appearance of the connection interface 201. As illustrated in FIG. 4, the connection interface 201 includes a pair of connection terminals 202 arranged in a recess portion 203 where the cartridge memory 20 can be received. When the cartridge memory 20 is set in the recess portion 203, the connection terminals 202 electrically contacts the connection terminals 22 of the cartridge memory 20, enabling communication between the remanufacturing apparatus 200 and the cartridge memory 20.

Prior to remanufacture of individual cartridges, the remanufacturing apparatus 200 generates a first key pair, that is, a first private key K_{S1} and a first public key K_{P1}, for a digital signature of information to be written to the cartridge memory in advance and stores the first key pair internally.

The remanufacturing apparatus 200, at the time of remanufacturing the cartridge 10, obtains characteristic information representing characteristics of the component elements of the remanufactured cartridge 10 on the basis of an input by the remanufacturer, for example, and generates a digital signature of the obtained characteristic information using the first private key K_{S1}. Then, the remanufacturing apparatus 200 writes the generated digital signature and the first public key K_{P1} together with the characteristic information to the cartridge memory 20 of the cartridge 10.

The user purchases the cartridge 10 remanufactured in this manner and attaches the purchased cartridge 10 to the printer 100 for reuse. Note that, naturally, the printer to which the remanufactured cartridge 10 is attached may be, in practice, different from the printer to which the cartridge 10 was attached before remanufacture. Before using the characteristic information read out from the cartridge memory 20 for controlling the image-forming operation, the printer 100 verifies the characteristic information on the basis of the digital signature read out together with the characteristic information. The first public key K_{P1} read out from the cartridge memory 20 is used in the verification of the characteristic information, but if the first public key K_{P1} is not reliable, it cannot be said that the characteristic information can be safely used even if the verification based on the digital signature is successful.

Thus, in the present embodiment, an electronic certificate issued by the certificate authority 50 described above is introduced in the mechanism for authenticating the cartridge 10. The certificate authority 50 generates a second key pair, that is, a second private key K_{S2} and a second public key K_{P2}, for issuing an electronic certificate C_{X} in advance and secretly manages the second private key K_{S2}. At the time of manufacturing of the printer 100, the manufacturer of the printer 100 stores the second public key K_{P2} generated by the certificate authority 50 in an internal memory of the printer 100. The certificate authority 50 issues an electronic certificate C_{P1} for certifying reliability of the first public key K_{P1} in response to a request from the remanufacturing apparatus 200. The remanufacturing apparatus 200 writes this electronic certificate C_{P1} to the cartridge memory 20 together with the first public key K_{P1} at the time of remanufacturing the cartridge 10. Accordingly, when verifying the characteristic information read out from the remanufactured cartridge 10, the printer 100 can determine whether or not the first public key K_{P1} is reliable using the electronic certificate C_{P1} and the second public key K_{P2}. Even if many cartridges are collected and remanufactured, as long as the electronic certificate C_{P1} is valid, it is sufficient for the remanufacturer to access the certificate authority 50 once in advance and receive the issuance of the electronic certificate C_{P1}. This means that it is not necessary for the remanufacturing apparatus 200 to access the certificate authority 50 each time the cartridge is remanufactured.

In the present embodiment, typically, the remanufacturer may be a service provider commissioned by the manufacturer of new product devices. Since the electronic certificate described above is issued only to a valid commissioned remanufacturer by the certificate authority 50 operated for the manufacturer, users can safely purchase and use a remanufactured product without worrying about the risk of poor operation or quality degradation. Accordingly, reuse of devices that can be attached and detached is encouraged, and environmental burdens related to image-forming apparatuses are reduced.

A configuration of each apparatus for implementing the authentication system 1 described above will be described in detail in the next section.

### 2. Configuration of Each Apparatus

### <2-1. Configuration of Certificate Authority>

FIG. 5 is a block diagram illustrating an example of the configuration of the certificate authority 50. The certificate authority 50 includes a central processing unit (CPU) 51, a memory 52, a communication unit 53, and a key management unit 54.

The CPU 51 is control circuitry that controls the overall operations of the certificate authority 50 by executing a computer program. The memory 52 may include a volatile or non-volatile storage medium and stores computer programs executed by the CPU 51 and various data. The communication unit 53 is a communication interface for the certificate authority 50 to communicate with other apparatuses via the network N1. The key management unit 54 is a unit that manages the encryption keys required for issuing electronic certificates.

In the present embodiment, the CPU 51 functions as a key pair generation unit 61 and a certificate issuing unit 62. At the time of manufacturing of the printer 100, the key pair generation unit 61 generates the second key pair consisting of the second private key K_{S2} and the second public key K_{P2} described above and stores the second private key K_{S2} in a storage medium of the key management unit 54 with anti-tampering properties. FIG. 5 illustrates an example in which the key management unit 54 holds one second private key K_{S2}, but the key management unit 54 may hold different second private keys for a plurality of printers that may exist under management of the system. The second public key K_{P2} is stored in an encryption processing unit 113 of the printer 100 described below. The certificate issuing unit 62 issues an electronic certificate certifying reliability of the first public key K_{P1} in response to a certificate issuing request received together with the first public key K_{P1} described above from the remanufacturing apparatus 200. An example of a flow of certificate preparation processing involving the certificate authority 50 will be further described below.

### <2-2. Configuration of Remanufacturing Apparatus>

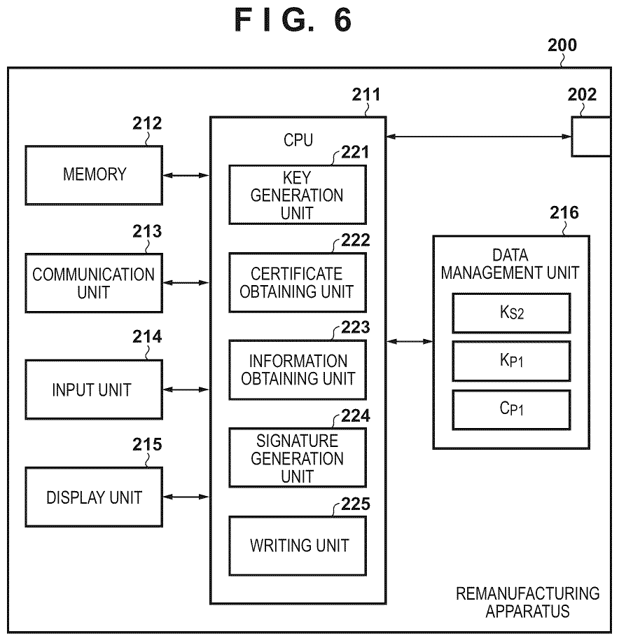

FIG. 6 is a block diagram illustrating an example of the configuration of the remanufacturing apparatus 200. The remanufacturing apparatus 200 includes the connection terminals 202, a CPU 211, a memory 212, a communication unit 213, an input unit 214, a display unit 215, and a data management unit 216. The connection terminals 202 function as the connection interface for the remanufacturing apparatus 200 to connect to the cartridge 10.

The CPU 211 is control circuitry that controls the overall operations of the remanufacturing apparatus 200 by executing a computer program. The memory 212 may include a volatile or non-volatile storage medium and stores computer programs executed by the CPU 211 and various data. The communication unit 213 is a communication interface for the remanufacturing apparatus 200 to communicate with the certificate authority 50 via the network N1. The input unit 214 is an input device for the remanufacturing apparatus 200 to accept user inputs. The display unit 215 is a display for displaying information to the user of the remanufacturing apparatus. The data management unit 216 manages security-related data for writing information of the cartridge 10.

In the present embodiment, the CPU 211 functions as a key generation unit 221, a certificate obtaining unit 222, an information obtaining unit 223, a signature generation unit 224, and a writing unit 225. Prior to remanufacturing of the cartridge 10, the key generation unit 221 generates the first key pair consisting of the first private key K_{S1} and the first public key K_{P1} described above. The key generation unit 221 may generate the first key pair according to an algorithm of any public key encryption method such as the Edwards-curve digital signature algorithm (EdDSA) or RSA. The certificate obtaining unit 222 transmits a certificate issuing request including the first public key K_{P1} to the certificate authority 50 and obtains the electronic certificate C_{P1} issued by the certificate authority 50 in response to the certificate issuing request. The electronic certificate C_{P1} certifies the reliability of the first public key K_{P1}. The data management unit 216 stores therein in advance the first private key K_{S1} for signature generation generated by the key generation unit 221 and the corresponding first public key K_{P1} and the electronic certificate C_{P1} obtained by the certificate obtaining unit 222.

At the time of remanufacturing the cartridge 10, the information obtaining unit 223 obtains remanufacturing information specific to the cartridge 10 after the remanufacturing. For example, the remanufacturing information obtained by the information obtaining unit 223 may include identification information for identifying the remanufactured cartridge 10 and characteristic information representing the characteristics of the component elements of the remanufactured cartridge 10. The signature generation unit 224 generates a digital signature for the remanufacturing information using the first private key K_{S1}. The writing unit 225 writes to the cartridge memory 20 the remanufacturing information obtained by the information obtaining unit 223, the digital signature generated by the signature generation unit 224, and the first public key K_{P1} and the electronic certificate C_{P1} stored in the data management unit 216. An example of a flow of writing processing executed at the time of remanufacturing the cartridge will be further described below.

### <2-3. Configuration of Cartridge>

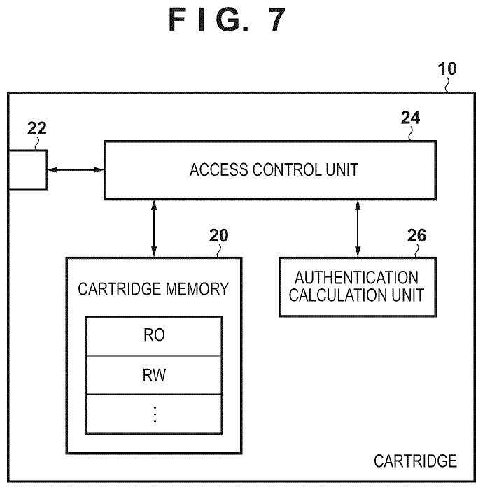

FIG. 7 is a block diagram illustrating an example of the configuration of the cartridge 10. The cartridge 10 includes the cartridge memory 20, the connection terminals 22, an access control unit 24, and an authentication calculation unit 26. The cartridge memory 20 includes a read-only storage area and a rewritable storage area. The connection terminals 22 function as a connection interface for connecting to the remanufacturing apparatus 200 at the time of remanufacturing the cartridge 10.

The access control unit 24 is control circuitry that controls reading of information from the cartridge memory 20 and writing of information to the cartridge memory 20 on the basis of instructions received from an external apparatus. For example, when the access control unit 24 receives a reading instruction designating a specific address of the cartridge memory 20 from an external apparatus, the access control unit 24 reads out the information stored at the designated address and transmits the read-out information to an external apparatus via the connection terminals 22. Also, when the access control unit 24 receives a writing instruction designating a specific address from an external apparatus, the access control unit 24 executes different processing depending on whether the designated address belongs to a rewritable storage area. In a case where the designated address belongs to a read-only storage area, the access control unit 24 does not allow the information to be written to the address. In a case where the designated address belongs to a rewritable storage area, the access control unit 24 writes the information included in the writing instruction to the address.

The authentication calculation unit 26 performs authentication calculations related to the use and remanufacture of the cartridge 10. For example, when the cartridge 10 is attached to the printer 100, challenge response authentication for verifying the authenticity of the cartridge 10 may be performed. In this case, the authentication calculation unit 26 generates a challenge to be transmitted to the printer 100 and performs response calculations based on the challenge.

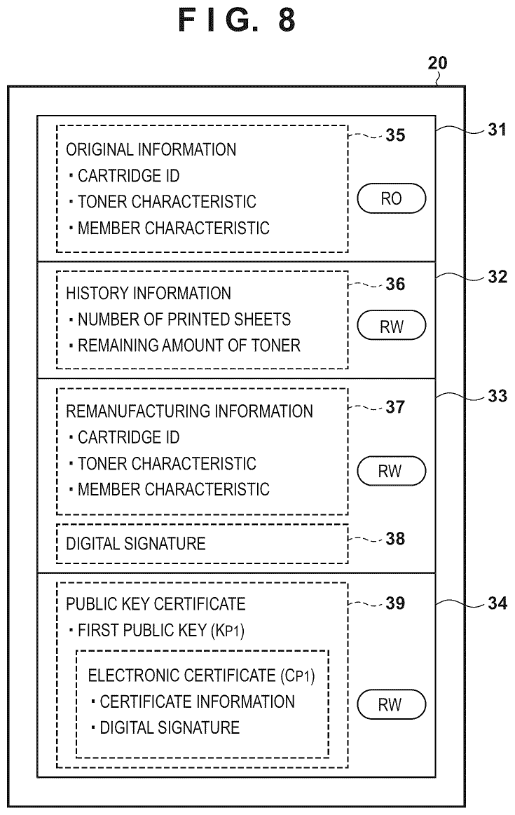

FIG. 8 is an explanatory diagram of an example of a configuration of a storage area of the cartridge memory 20. As illustrated in FIG. 8, the cartridge memory 20 includes a first storage area 31, a second storage area 32, a third storage area 33, and a fourth storage area 34.

The first storage area 31 is a read-only storage area (the label “RO” means read-only). The first storage area 31 stores original information 35 specific to the cartridge 10 as a new product (in other words, before remanufacture). In the example of FIG. 8, the original information 35 includes cartridge identification information (ID), toner characteristic information, and member characteristic information. The cartridge ID is information for identifying the individual cartridge 10 as a new product. The cartridge ID may be in any format and may be a combination of a manufacture date and a serial number (which is reset each time the date changes). The toner characteristic information is information representing the characteristics of the toner housed in the cartridge 10. For example, the toner characteristic information may include a parameter representing the color component of the toner housed in the cartridge 10 (for example, “Black”). Also, the toner characteristic information may include a parameter representing the amount of toner replenished into the cartridge 10 at the time of manufacture (using the number of sheets as units, for example, “1000 sheets”). The member characteristic information is information representing the characteristics of the members constituting the cartridge 10. For example, the member characteristic information may include a parameter representing one or more of the optimal charging voltage, development voltage, transfer voltage, amount of laser light, and process speed. Note that a part of the cartridge ID may represent the toner characteristics or the member characteristics (for example, a letter of the alphabet at a specific position may represent the toner color or the like). In such a case, the cartridge ID may be treated as characteristic information.

The second storage area 32 is a rewritable storage area (the label “RW” means rewritable). The second storage area 32 stores history information 36 indicating the use history of the cartridge 10. In the example of FIG. 8, the history information 36 includes two parameters, the number of printed sheets and the remaining amount of toner. The number of printed sheets indicates the cumulative number of sheets printed as a result of execution of image formation jobs. The value of the number of printed sheets may be initialized to zero at the time of first manufacture and at the time of remanufacture and may be counted up each time the printer 100 executes an image formation job. The remaining amount of toner indicates the percentage of the estimated amount of toner remaining inside the cartridge 10 with respect to the maximum value, for example.

The third storage area 33 is a rewritable storage area. The third storage area 33 stores remanufacturing information 37 specific to the remanufactured cartridge 10 and a digital signature 38. In the example of FIG. 8, the remanufacturing information 37 has a similar format to the original information and includes cartridge ID, toner characteristic information, and member characteristic information. The cartridge ID may be a combination of a date when the cartridge 10 was remanufactured and a unique serial number within a range of the date, for example. The digital signature 38 is a digital signature generate by the signature generation unit 224 of the remanufacturing apparatus 200 using the first private key K_{S1}. The digital signature 38 is used to verify the authenticity of the characteristic information when the characteristic information of the remanufactured cartridge 10 is read out from the cartridge memory 20 by the printer 100 and used.

In the initial state, a duplicate of the original information 35 may be written to the third storage area 33. In this case, the digital signature 38 may be generated on the basis of the original information 35.

The fourth storage area 34 is a rewritable storage area. The fourth storage area 34 stores a public key certificate 39 for the first public key K_{P1} used to verify the digital signature 38. As illustrated in FIG. 8, the public key certificate 39 includes the first public key K_{P1} and the electronic certificate C_{P1}. The electronic certificate C_{P1}, for example, may have any known certificate format such as X.509 and includes a certificate number and other certificate information as well as a digital signature generated on the basis of the first public key and the certificate information.

### <2-4. Configuration of Printer>

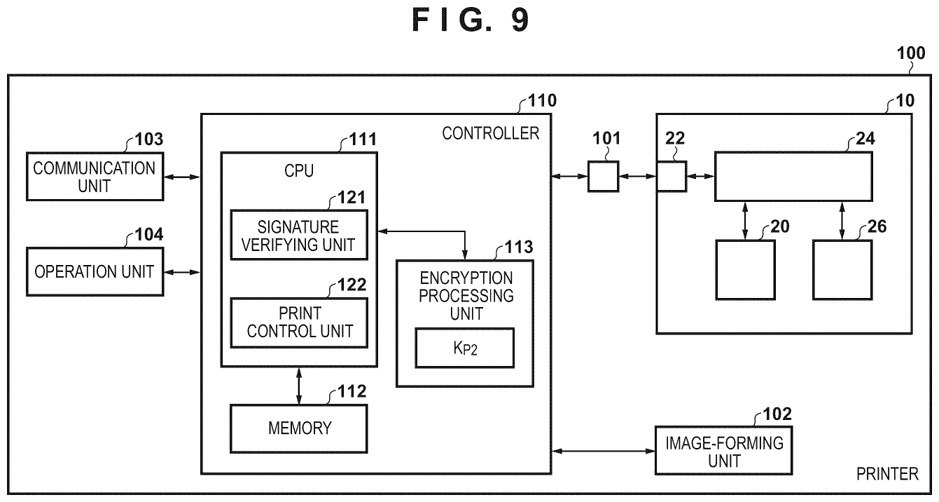

FIG. 9 is a block diagram illustrating an example of the configuration of a control function of the printer 100 to which the cartridge 10 is attached. In the example of FIG. 9, the printer 100 includes, in addition to the cartridge 10, the connection terminal 101, an image-forming unit 102, a communication unit 103, an operation unit 104, and the controller 110. The connection terminal 101 functions as a connection interface for the cartridge 10 to connect to the printer 100.

The image-forming unit 102 cooperates with the members included in the cartridge 10 to form an image on a sheet. The image-forming operation executed by the image-forming unit 102 is as described using FIG. 3. The communication unit 103 is a communication interface for the printer 100 to communicate with other apparatuses via the network N1. The operation unit 104 provides a user interface to the user of the printer 100. The operation unit 104 may include, for example, an input device such as a touch panel, a button, and a mouse and an output device such as a display and a speaker.

The controller 110 includes a CPU 111, a memory 112, and the encryption processing unit 113. The CPU 111 controls the overall operations of the printer 100 by executing a computer program. The memory 112 may include a volatile or non-volatile storage medium and stores computer programs executed by the CPU 111 and various data.

The encryption processing unit 113 includes a processor for executing encryption processing related to authentication of the cartridge 10 and a memory for storing the encryption keys used in authentication. In the present embodiment, the memory of the encryption processing unit 113 pre-stores the second public key K_{P2}. The second public key K_{P2} is a key corresponding to the second private key K_{S2} used when the certificate authority 50 issues the electronic certificate C_{P1} to the remanufacturer of the cartridge 10. The encryption processing unit 113 can calculate a hash value from a message and decrypt a digital signature received together with the message. If the hash value obtained as a result of decrypting the digital signature and the hash value calculated from the message are equal, it is determined that the message has not been tampered with. Such encryption processing may be executed both in the certificate verification and the signature verification described below. In addition, for challenge response authentication at the time of the cartridge 10 being attached to the printer 100, the encryption processing unit 113 may generate a challenge to be transmitted to the cartridge 10 and may perform response calculation based on the challenge.

In the present embodiment, the CPU 111 functions as a signature verifying unit 121 and a print control unit 122. The signature verifying unit 121 is verification circuitry that, when the cartridge 10 is attached to the printer 100, reads out the remanufacturing information 37 and the digital signature 38 described above from the third storage area 33 of the cartridge memory 20 and verifies the authenticity of the remanufacturing information 37 on the basis of the digital signature 38. The first public key K_{P1} to be used in the signature verification is included in the public key certificate 39 read out from the fourth storage area 34 of the cartridge memory 20. In order to determine whether the first public key K_{P1} is reliable, the signature verifying unit 121 executes verification processing using the electronic certificate C_{P1} included in the public key certificate 39 and the second public key K_{P2} stored in the encryption processing unit 113. Then, in a case where the first public key K_{P1} is determined to be reliable, the signature verifying unit 121 uses the first public key K_{P1} to verify the remanufacturing information (for example, characteristic information) based on the digital signature 38 described above. Examples of a flow of such verification processing will be further described below.

The print control unit 122 controls the execution of print jobs. Execution of a print job is instructed by an external host computer (not illustrated) via the communication unit 103, for example, or via the operation unit 104 by a user. When job execution is instructed, the print control unit 132 controls the image-forming unit 102 to form an image on a sheet using the image-forming condition determined on the basis of the characteristic information read out from the cartridge memory 20. The characteristic information read out from the cartridge memory 20 of the remanufactured cartridge 10 is allowed in a case where verification of the information by the signature verifying unit 121 is successful.

### 3. Processing Flow

In the present section, examples of flows of the processing that may be executed in the authentication system 1 described above will be described in detail.

### <3-1. Certificate Preparation Processing>

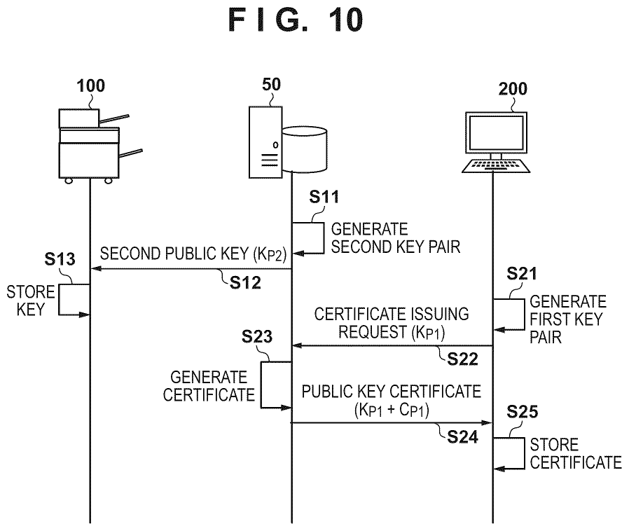

FIG. 10 is a sequence diagram illustrating an example of a flow of the certificate preparation processing executed prior to remanufacture. The certificate authority 50, the printer 100, and the remanufacturing apparatus 200 are mainly involved in the certificate preparation processing illustrated in FIG. 10. Note that in the following description, processing step is abbreviated to “S”.

First, when the printer 100 is manufactured, in S11, the key pair generation unit 61 of the certificate authority 50 generates the second key pair consisting of the second private key K_{S2} and the second public key K_{P2}. The key management unit 54 stores the generated second private key K_{S2}. In S12, the second public key K_{P2} is passed to the printer 100. In S13, the second public key K_{P2} is stored in the memory of the encryption processing unit 113 of the controller 110 of the printer 100.

In S21, the key generation unit 221 of the remanufacturing apparatus 200 generates the first key pair consisting of the first private key K_{S1} and the first public key K_{P1}. The data management unit 216 stores the generated first private key K_{S1}. In S22, the certificate obtaining unit 222 transmits a certificate issuing request including the first public key K_{P1} to the certificate authority 50. In S23, the certificate issuing unit 62 of the certificate authority 50 generates the electronic certificate C_{P1} for certifying the reliability of the first public key K_{P1} in response to the certificate issuing request from the remanufacturing apparatus 200. In S24, a public key certificate including the first public key K_{P1} and the electronic certificate C_{P1} generated by the certificate issuing unit 62 are passed to the remanufacturing apparatus 200. In S25, the certificate obtaining unit 222 stores the public key certificate in the data management unit 216.

Note that passing the second public key K_{P2} in S12 and passing the public key certificate in S24 may be performed via a secure communication path constructed on the network N1 or by physically delivering the data stored in a storage medium.

### <3-2. Writing Processing>

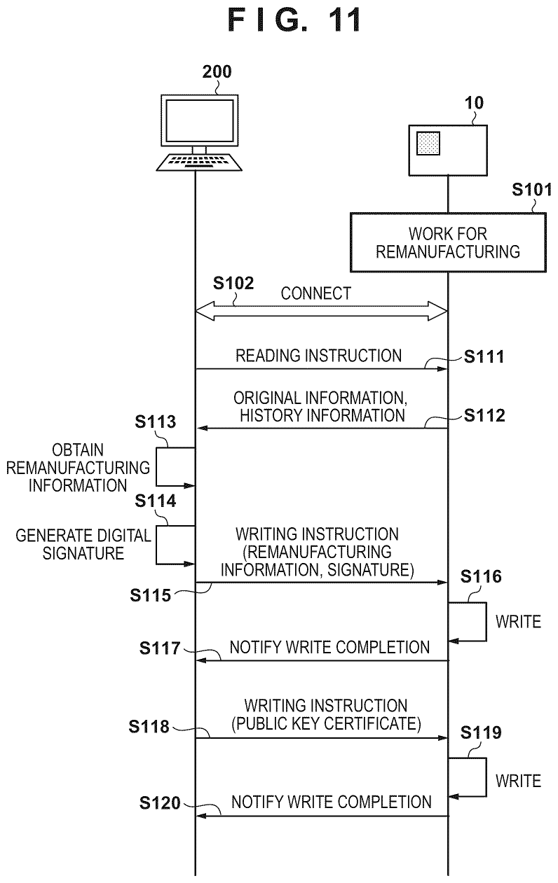

FIG. 11 is a sequence diagram illustrating an example of a flow of the writing processing executed at the time of remanufacture of the cartridge. The cartridge 10 and the remanufacturing apparatus 200 are mainly involved in the writing processing illustrated in FIG. 11.

Prior to the writing processing, in S101, the remanufacturer carries out remanufacturing work including replenishing the toner and replacing worn members in the cartridge 10. Upon completing this work, in S102, the remanufacturer connects the cartridge 10 to the connection interface 201 of the remanufacturing apparatus 200. Thereafter, when the CPU 211 of the remanufacturing apparatus 200 runs the computer program for writing the remanufacturing information, the writing processing is started.

In S111, the information obtaining unit 223 transmits to the cartridge 10 a reading instruction for reading out the original information and the history information stored in the first storage area 31 and the second storage area 32 of the cartridge memory 20. In S112, the access control unit 24 of the cartridge 10 transmits the original information and the history information read out from the cartridge memory 20 to the remanufacturing apparatus 200.

Note that the reading out of the original information and the history information may be performed before the remanufacturing work of S101. In this case, the remanufacturer may determine what amount of toner to replenish or what member to replace in accordance with the remaining amount of toner and the degree of wear of the other members indicated by the history information.

In S113, the information obtaining unit 223 obtains remanufacturing information specific to the remanufactured cartridge 10. The remanufacturing information may be received via a user interface provided by the input unit 214 and the display unit 215 of the remanufacturing apparatus 200 or may be received (in a data file format, for example) via the communication unit 213 from a certain external apparatus. The remanufacturing information, as described above, may include identification information for identifying the remanufactured cartridge 10 and characteristic information indicating the characteristics of the component elements of the remanufactured cartridge 10.

In S114, the signature generation unit 224 generates a digital signature for the remanufacturing information obtained in S113 using the first private key K_{S1} stored in the data management unit 216. The digital signature may be generated according to any known signature generation method such as a digital signature algorithm (DSA) method or an elliptic curve DSA (ECDSA) method, for example. The signature generation unit 224 may generate a digital signature for an information set including the original information obtained in S112 together with the remanufacturing information. In this manner, the signature values of the digital signatures is always different between different cartridges, preventing illicit reusing of the remanufacturing information and the digital signature.

In S115, the writing unit 225 transmits to the cartridge 10 a writing instruction for writing the remanufacturing information and the digital signature to the third storage area 33. In S116, the access control unit 24 of the cartridge 10 writes the remanufacturing information and the digital signature to the third storage area 33 of the cartridge memory 20 in response to receiving the writing instruction. In S117, the access control unit 24 notifies the remanufacturing apparatus 200 of write completion.

Also, in S118, the writing unit 225 transmits to the cartridge 10 a writing instruction for writing the public key certificate (including the first public key K_{P1} and the electronic certificate C_{P1}) stored in the data management unit 216 to the fourth storage area 34. In S119, the access control unit 24 of the cartridge 10 writes the public key certificate to the fourth storage area 34 of the cartridge memory 20 in response to receiving the writing instruction. In S120, the access control unit 24 notifies the remanufacturing apparatus 200 of write completion.

### <3-3. Cartridge Authentication Processing>

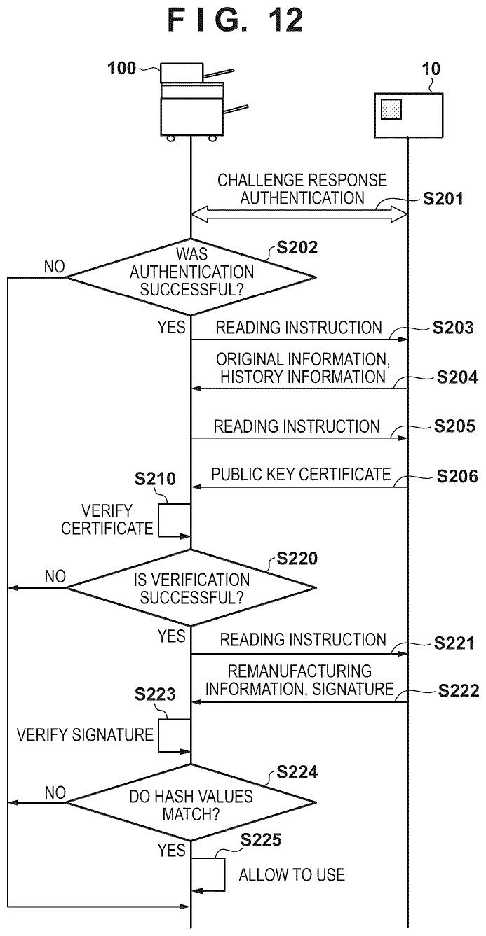

FIG. 12 is a sequence diagram illustrating an example of a flow of the cartridge authentication processing executed by the printer 100. The cartridge 10 and the printer 100 are mainly involved in the cartridge authentication processing illustrated in FIG. 12.

First, in S201, the signature verifying unit 121 of the printer 100 that has detected that the cartridge 10 is attached to it performs a challenge response authentication with the access control unit 24 of the cartridge 10. The challenge response authentication here may be performed according to any known method, and the flow will not be described here in detail. In S202, the signature verifying unit 121 determines whether or not the challenge response authentication was successful. In a case where the challenge response authentication was unsuccessful, the subsequent processing steps of FIG. 12 are skipped. In a case where the challenge response authentication was successful, the processing proceeds to S203.

In S203, the signature verifying unit 121 transmits to the cartridge 10 a reading instruction for reading out the original information and the history information stored in the first storage area 31 and the second storage area 32 of the cartridge memory 20. In S204, the access control unit 24 of the cartridge 10 transmits the original information and the history information read out from the cartridge memory 20 to the printer 100.

In S205, the signature verifying unit 121 transmits to the cartridge 10 a reading instruction for reading the public key certificate stored in the fourth storage area 34 of the cartridge memory 20. In S206, the access control unit 24 of the cartridge 10 transmits the public key certificate read out from the cartridge memory 20 to the printer 100.

In S210, the signature verifying unit 121 executes certificate verification processing for determining reliability of the first public key K_{P1} included in the public key certificate. Some embodiment examples of a detailed flow of the certificate verification processing will be further described below. The subsequent processing branches at S220 depending on the result of the certificate verification processing. In a case where, in the certificate verification processing, the first public key K_{P1} is not determined to be reliable, the subsequent processing steps of FIG. 12 are skipped. In a case where, in the certificate verification processing, the first public key K_{P1} is determined to be reliable, the processing proceeds to S221.

In S221, the signature verifying unit 121 transmits to the cartridge 10 a reading instruction for reading out the remanufacturing information stored in the third storage area 33 of the cartridge memory 20. In S221, the access control unit 24 of the cartridge 10 transmits the remanufacturing information and the digital signature read out from the cartridge memory 20 to the printer 100.

In S223, the signature verifying unit 121 verifies the authenticity of the remanufacturing information (in particular, the characteristic information) read out from the cartridge memory 20 on the basis of the digital signature read out together with the remanufacturing information. Specifically, the signature verifying unit 121 causes the encryption processing unit 113 to calculate the hash value of the remanufacturing information and decrypt the digital signature using the second public key K_{P2}. In S224, the signature verifying unit 121 determines whether the hash value obtained as the result of the decrypting of the digital signature matches the hash value of the remanufacturing information.

In a case where, in S224, the two hash values match, the signature verification is successful. Then, in S225, the signature verifying unit 121 allows the print control unit 122 to control the image-forming operation using the characteristic information included in the remanufacturing information. The signature verifying unit 121 displays the result of the authentication and the verification on the screen of the operation unit 104 and stores these in the memory 112.

In a case where either the challenge response authentication, the certificate verification, or the signature verification fails, the signature verifying unit 121 does not allow the characteristic information included in the remanufacturing information to be used. In this case, the signature verifying unit 121 may display a warning about the use of the cartridge 10 on the screen of the operation unit 104. The signature verifying unit 121 may prohibit the use of the cartridge 10, and if the user who received the warning selects to continue to use the cartridge 10, use of the cartridge 10 may be allowed.

### <3-4. Certificate Verification Processing>

As described using FIG. 8, the electronic certificate written together with the first public key to the cartridge memory 20 includes certificate information and a digital signature in accordance with a predetermined format. The certificate information may include the following items, for example:
“Certificate Number”
“Signature Algorithm”
“Issuer”
“Validity Period”
“Main Entity”
   “Certificate Number” is a number (serial number) for uniquely identifying each electronic certificate issued by the certificate authority 50. “Signature Algorithm” indicates the algorithm used to generate the digital signature included in the electronic certificate. “Issuer” indicates the name of the service provider or organization that operates the certificate authority 50. “Validity Period” indicates the start date and the end date of the validity period for each electronic certificate. “Main Entity” indicates the name of the service provider that owns the private key corresponding to each electronic certificate.

In the certificate verification processing executed in S210 of FIG. 12, in addition to the verification of the hash value based on the digital signature of the electronic certificate, various verifications may be performed based on the certificate information described above. Herein, three embodiment examples of the certificate verification processing will be described.

### (1) First Embodiment Example

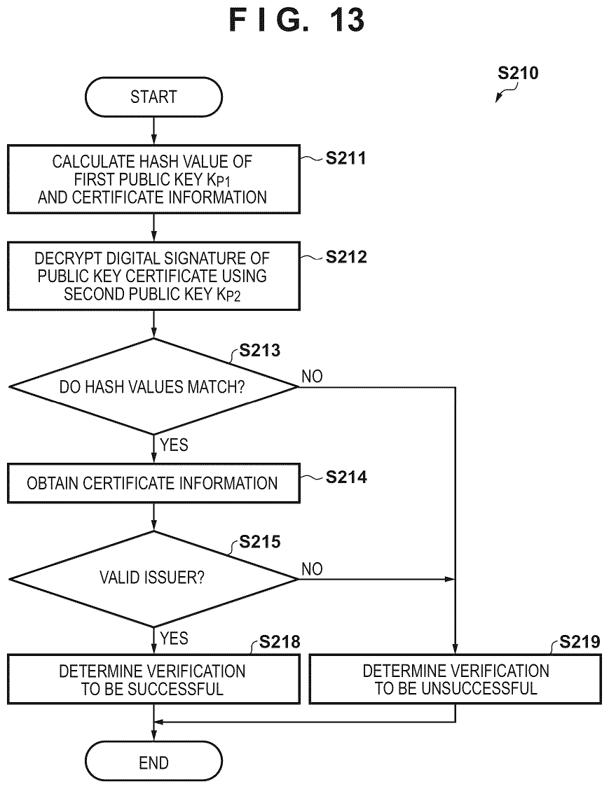

FIG. 13 is a flowchart illustrating an example of the flow of the certificate verification processing according to a first embodiment example.

First, in S211, the signature verifying unit 121 causes the encryption processing unit 113 to calculate the hash value of the first public key K_{P1} and the certificate information. Also, in S212, the signature verifying unit 121 causes the encryption processing unit 113 to decrypt the digital signature of the public key certificate using the second public key K_{P2}. Next, in S213, the signature verifying unit 121 determines whether the hash value of the first public key K_{P1} and the certificate information matches the hash value obtained as a result of decrypting the digital signature. In a case where the two hash values match, the processing proceeds to S214. In a case where the two hash values do not match, the processing proceeds to S219.

In S214, the signature verifying unit 121 obtains the certificate information from the public key certificate. The certificate information includes the name of the issuer of the public key certificate. In S215, the signature verifying unit 121 determines whether the issuer indicated by the certificate information is a valid issuer by comparing the name of the issuer with a predetermined name (predefined as the name of a valid issuer). A valid issuer here may be the manufacturer of the cartridge 10 or a third party commissioned by the manufacturer that operates the certificate authority 50. In a case where it is determined that the issuer of the public key certificate is a valid issuer, the processing proceeds to S218. In a case where it is determined that the issuer of the public key certificate is not a valid issuer, the processing proceeds to S219.

In S218, the signature verifying unit 121 determines that the certificate verification is successful and that the first public key K_{P1} is reliable. Meanwhile, in S219, the signature verifying unit 121 determines that the certificate verification is unsuccessful and that the first public key K_{P1} is not reliable.

In the first example, in a case where an electronic certificate issued by an issuer that is not a valid issuer is written to the cartridge 10, it is possible to prohibit the cartridge 10 from being used or to warn a user about the risk of using the cartridge 10.

### (2) Second Embodiment Example

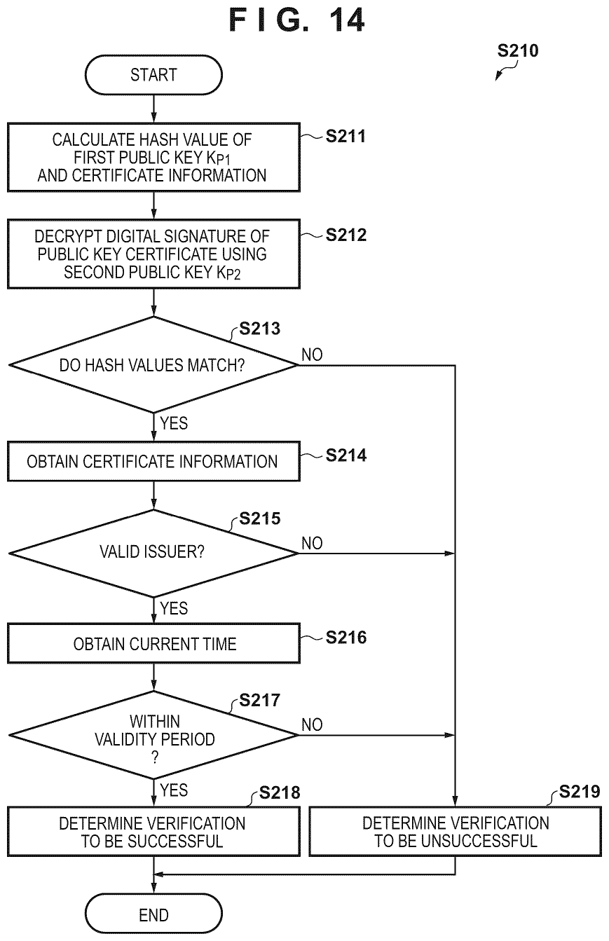

FIG. 14 is a flowchart illustrating an example of the flow of the certificate verification processing according to a second embodiment example. S211 to S215 of FIG. 14 are the same as S211 to S215 of FIG. 13, and thus redundant description of these will be omitted. In S215, in a case where it is determined that the issuer of the public key certificate is a valid issuer, the processing proceeds to S216.

In S216, the signature verifying unit 121 references an internal clock in the printer 100 or receives time information from an external time server to obtain the current time. In S217, the signature verifying unit 121 determines whether or not the obtained current time is within the validity period of the electronic certificate indicated by the certificate information. In a case where the current time is within the validity period of the electronic certificate, the processing proceeds to S218. In a case where the current time is not within the validity period of the electronic certificate and the validity period has already elapsed, the processing proceeds to S219.

In S218, the signature verifying unit 121 determines that the certificate verification is successful and that the first public key K_{P1} is reliable. Meanwhile, in S219, the signature verifying unit 121 determines that the certificate verification is unsuccessful and that the first public key K_{P1} is not reliable.

Note that according to a modification example of the second embodiment example, the signature verifying unit 121 may determine whether or not the time at which the electronic certificate was written to the cartridge 10, instead of the current time at which the cartridge authentication is performed, is within the validity period. In this case, the time of writing the electronic certificate is additionally included in the certificate information.

In the second embodiment example, the service provider or organization that operates the certificate authority 50 can restrict, via a validity period set in the electronic certificate, the time period during which the remanufacturer can validly remanufacture the device and sell it or the time period during which the remanufactured product device can be used. For example, the manufacturer can monitor the quality of remanufactured products available on the market after issuing an electronic certificate and take measures to not issue an electronic certificate next time to remanufacturers that are selling low quality remanufactured products.

### (3) Third Example

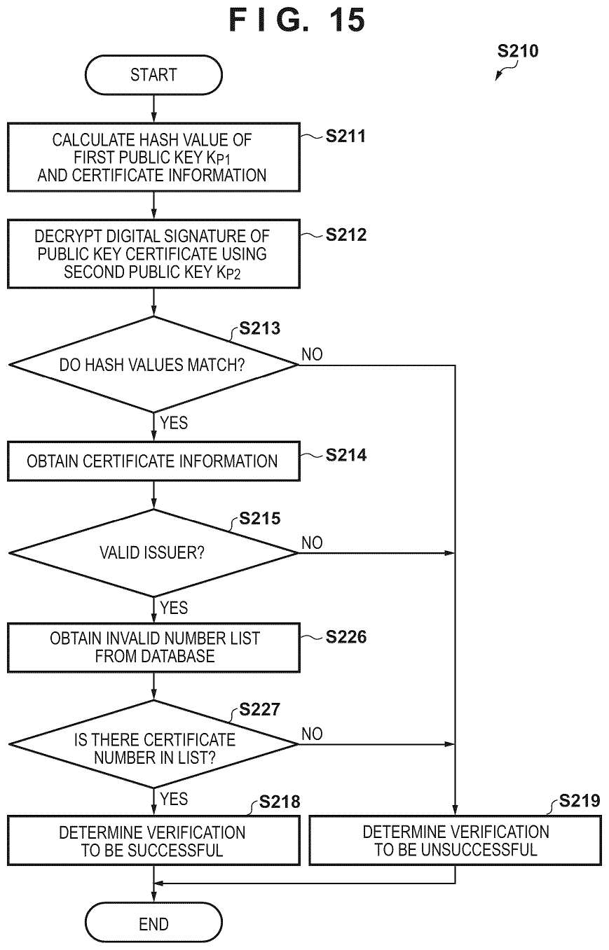

FIG. 15 is a flowchart illustrating an example of the flow of the certificate verification processing according to a third embodiment example. In the third embodiment example, the printer 100 is capable of accessing the certificate database where identification information (for example, certificate number) of invalid electronic certificates are registered via the network N1. The certificate database, for example, is provided by the manufacturer of the cartridge 10 or the organization operating the certificate authority 50, and the numbers of the electronic certificate suspected of illicit actions are registered in the certificate database.

S211 to S215 of FIG. 15 are the same as S211 to S215 of FIG. 13, and thus redundant description of these will be omitted. In S215, in a case where it is determined that the issuer of the public key certificate is a valid issuer, the processing proceeds to S226.

In S226, the signature verifying unit 121 obtains an invalid number list listing the certificate numbers of invalid electronic certificates from the database described above. In S227, the signature verifying unit 121 compares the certificate number indicated by the certificate information obtained in S214 with the invalid number list obtained in S226. In a case where the certificate number indicated by the certificate information is not in the invalid number list, the processing proceeds to S218. In a case where the certificate number indicated by the certificate information is in the invalid number list, the processing proceeds to S219.

In S218, the signature verifying unit 121 determines that the certificate verification is successful and that the first public key K_{P1} is reliable. Meanwhile, in S219, the signature verifying unit 121 determines that the certificate verification is unsuccessful and that the first public key K_{P1} is not reliable.

In the third embodiment example, by registering the identification information of electronic certificates suspected of illicit actions in a database in advance, the reuse of devices using these electronic certificates can be prevented.

Note that according to a modification example of the third embodiment example, an expiration date of when the electronic certificate became invalid may be associated with the certificate number of each electronic certificate and registered in the certificate database. In this case, the signature verifying unit 121 may determine that an electronic certificate is invalid if the expiration date registered in the certificate database has been reached.

The embodiment examples and modification examples describe in the present section may be combined in any manner. For example, in the certificate verification processing, the validity period determination according to the second embodiment example and the comparison with the invalid number list of certificate numbers according to the third embodiment example may both be performed.

### 4. Supplement

Various embodiments, embodiment examples, and modified examples of the technology according to the present disclosure have been described above in detail using FIGS. 1 to 15. According to the embodiments described above, an information processing apparatus for remanufacturing a device that can be attached to and detached from an image-forming apparatus is provided. The device includes a memory that has a rewritable storage area and a component element involved in an image-forming operation. The information processing apparatus includes a storage configured to pre-store a first private key for signature generation, a first public key corresponding to the first private key, and an electronic certificate for certifying reliability of the first public key and a connection interface for the information processing apparatus to connect to the device. The information processing apparatus obtains characteristic information indicating a characteristic of the component element after remanufacture, generates a digital signature of the characteristic information using a first private key, and writes the obtained characteristic information, the generated digital signature, the first public key, and the electronic certificate to the storage area of the memory. According to this configuration, the need to communicate with an external server to ensure the reliability of the information to be written to the memory of the device each time the device is remanufactured is removed. In this manner, while ensuring the reliability of the remanufactured product, the communication costs and calculation costs required for the remanufacture can be reduced.

In the embodiment described above, the information processing apparatus, prior to the remanufacture of the device, generates a first key pair including a first private key and a first public key and pre-stores the first private key and the first public key in the storage. Also, the information processing apparatus transmits a certificate issuing request including the first public key to a certificate authority associated with a manufacturer of the device and stores the electronic certificate issued by the certificate authority in response to the certificate issuing request in the storage. Accordingly, even if a large number of devices are collected and remanufactured by the remanufacturer, as long as the remanufacturer possesses a valid electronic certificate, the information processing apparatus described above does not need to access the certificate authority or another external server at the time of each remanufacture. Moreover, even if the manufacturer of the device described above is different from the remanufacturer, reliability of the remanufactured products can be guaranteed using private public key infrastructure (PKI), and it is thus possible to encourage flexible cooperation between service providers in order to reduce environmental burdens.

Furthermore, in the embodiments described above, the image-forming apparatus to which the remanufactured device is attached reads out the first public key and the electronic certificate from the storage area of the device and uses the read electronic certificate and a second public key pre-stored in the storage of the image-forming apparatus to determine whether the read first public key is reliable. In a case where it is determined that the first public key is reliable, the image-forming apparatus uses the first public key to verify the characteristic information read out from the device on the basis of the digital signature read out together with the characteristic information. According to this configuration, the reliability of the first public key for verification of the digital signature accompanying the characteristic information read out from the remanufactured device to the image-forming apparatus is guaranteed by the electronic certificate issued for the remanufacturer in advance. Thus, the need for the apparatus of the remanufacturer to communicate with an external server each time the device is remanufactured is removed.

The technology according to the present specification may contribute to realization of a sustainable society such as a decarbonized/recycling-oriented society.

### 5. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-134474, filed on Aug. 9, 2024 which is hereby incorporated by reference herein in its entirety.

What is claimed is:

1. An information processing apparatus for remanufacturing a device that can be attached to and detached from an image-forming apparatus, the device including a memory that has a rewritable storage area and a component element involved in an image-forming operation by the image-forming apparatus, the information processing apparatus comprising:
a storage configured to pre-store a first private key for signature generation, a first public key corresponding to the first private key, and an electronic certificate for certifying reliability of the first public key;
a connection interface for the information processing apparatus to connect to the device; and
control circuitry, wherein the control circuitry is configured to:
obtain characteristic information representing a characteristic of the component element after remanufacture;
generate a digital signature of the characteristic information using the first private key; and
write the characteristic information, the digital signature, the first public key, and the electronic certificate to the storage area of the memory of the device.

2. The information processing apparatus according to claim 1, wherein the storage is configured to pre-store a first key pair including the first private key and the first public key generated by the information processing apparatus.

3. The information processing apparatus according to claim 2, wherein the control circuitry is configured to transmit a certificate issuing request including the first public key to a certificate authority associated with a manufacturer of the device and obtain the electronic certificate issued by the certificate authority in response to the certificate issuing request.

4. The information processing apparatus according to claim 3, wherein the manufacturer of the device is different from a remanufacturer that remanufactures the device.

5. The information processing apparatus according to claim 3, wherein the certificate authority is a private certificate authority.

6. The information processing apparatus according to claim 1, wherein the component element involved in the image-forming operation includes a development agent supplied from the device to the image-forming apparatus, and
the remanufacture of the device includes replenishing the device with the development agent.

7. The information processing apparatus according to claim 1, wherein the component element involved in the image-forming operation includes a member driven in the image-forming operation, and
the remanufacture of the device includes replacing the member.

8. An authentication system comprising:
the information processing apparatus according to claim 1; and
a certificate authority associated with a manufacturer of the device,
wherein the certificate authority is configured to issue the electronic certificate for certifying reliability of the first public key in response to a certificate issuing request received together with the first public key from the information processing apparatus, and
the storage of the information processing apparatus is configured to store the electronic certificate issued by the certificate authority prior to the remanufacture of the device.

9. A method for remanufacture of a device that can be attached to and detached from an image-forming apparatus performed using an information processing apparatus connected to the device, the device including a memory that has a rewritable storage area and a component element involved in an image-forming operation of the image-forming apparatus, and the information processing apparatus pre-storing a first private key for signature generation, a first public key corresponding to the first private key, and an electronic certificate for certifying reliability of the first public key, the method comprising:
obtaining characteristic information representing a characteristic of the component element after remanufacturing of the device;
generating a digital signature of the characteristic information using the first private key; and
writing the characteristic information, the digital signature, the first public key, and the electronic certificate to the storage area of the memory of the device from the information processing apparatus.

10. A computer-readable storage medium having stored therein a computer program that, when executed by a processor of an information processing apparatus connected to a device that can be attached to and detached from an image-forming apparatus, to causing the information processing apparatus to perform operations for remanufacture of the device, the device including a memory that has a rewritable storage area and a component element involved in an image-forming operation of the image-forming apparatus, and the information processing apparatus pre-storing a first private key for signature generation, a first public key corresponding to the first private key, and an electronic certificate for certifying reliability of the first public key, the operations comprising:
obtaining characteristic information representing a characteristic of the component element after remanufacturing of the device;
generating a digital signature of the characteristic information using the first private key; and
writing the characteristic information, the digital signature, the first public key, and the electronic certificate to the storage area of the memory of the device from the information processing apparatus.

11. An image-forming apparatus comprising:
an image-forming unit;
a connection interface for a device that can be attached to and detached from the image-forming apparatus to connect to the image-forming apparatus;
verification circuitry configured to verify characteristic information representing a characteristic of a component element of the device involved in an image-forming operation by the image-forming unit, read out from a rewritable storage area of the device, based on a digital signature read out together with the characteristic information from the storage area;
control circuitry configured to control the image-forming operation by the image-forming unit based on the characteristic information in a case where verification of the characteristic information by the verification circuitry is successful; and
a storage configured to pre-store a second public key corresponding to an electronic certificate for certifying reliability of a first public key for verification of the digital signature,
wherein the verification circuitry is configured to:
read out the first public key and the electronic certificate from the storage area of the device;
determine whether or not the first public key is reliable using the electronic certificate and the second public key stored in the storage; and
verify the characteristic information based on the digital signature using the first public key in a case where the first public key is determined to be reliable.

12. The image-forming apparatus according to claim 11, wherein the digital signature is generated using a first private key corresponding to the first public key and is written to the storage area of the device by an information processing apparatus of a remanufacturer that remanufactures the device.

13. The image-forming apparatus according to claim 11, wherein the second public key is a key corresponding to a second private key used when a certificate authority associated with a manufacturer of the device issues the electronic certificate to a remanufacturer that remanufactures the device.

14. The image-forming apparatus according to claim 13, wherein the certificate authority is a private certificate authority.

15. The image-forming apparatus according to claim 13, wherein the verification circuitry is configured to determine that the first public key is not reliable in a case where certificate information included in the electronic certificate does not indicate a predetermined issuer.

16. The image-forming apparatus according to claim 11, wherein the verification circuitry is configured to determine that the first public key is not reliable in a case where a validity period of the electronic certificate has already elapsed.

17. The image-forming apparatus according to claim 11, wherein the image-forming apparatus is capable of accessing a database in which identification information of invalid electronic certificates are registered, and
the verification circuitry is configured to determine that the first public key is not reliable in a case where identification information of the electronic certificate is registered in the database.
